(19) United States
(12) Patent Application Publication
(10) Pub. No.: US 2024/0239131 A1
(43) Pub. Date: Jul. 18, 2024

(54) Modular Desktop Organizer

(71) Applicant: Raymundo Mejia, Anaheim, CA (US)

(72) Inventor: Raymundo Mejia, Anaheim, CA (US)

(21) Appl. No.: 18/097,879

(22) Filed: Jan. 17, 2023

(51) Int. Cl. B43M 99/00

(52) U.S. Cl. CPC B43M 99/001; B43M 99/008

(57) ABSTRACT

A modular desk organizer has a bottom panel, a top panel, and side panels, which are custom manufactured and/or selected so that they can be assembled to form an assembled product that is customized to the needs of a particular consumer. The bottom panel includes interlocking features that are shaped to interlock with interlocking features of the side panels. Each of the side panel edges also have interlocking features that interlock with adjacent side panels. The top panel is mounted on top panel edges of the side panels. The top panel has apertures that are sized and shaped to receive pens, pencils, and such, therethrough.

### BACKGROUND OF THE INVENTION

### Field of the Invention

This invention relates generally to desk organizers, and more particularly to a modular desk organizer that can be produced in a highly customizable method of product that results in a modular desk organizer that is highly customized to the needs of a particular user.

### Description of Related Art

Desk organizers are well known in the office, and have many structures that are adapted to hold various forms of office supplies. For example, the top of a desk organizer often has holes for receiving pens and pencils so that they are stored vertically in the organizer. Other common structures are holder for paper clips, binder clips, and other items commonly used in an office.

The problem with most desk organizers is that they are mass produced to meet the needs of general workers, and are not able to accommodate the needs of a particular user. There is no customization of the product that makes the desk organizer particularly attractive and person to the user, and such customization is desired for a product that sits in a prominent position on a user's desk.

There is a long felt need in the art for a desk organizer that may be produced via a highly customized method of production that results in a modular desk organizer that is customized to a particular user, in both form and function. The present invention fulfills these needs and provides further advantages as described in the following summary.

### SUMMARY OF THE INVENTION

The present invention teaches certain benefits in construction and use which give rise to the objectives described below.

The present invention provides a modular desk organizer having a bottom panel, a top panel, and side panels. Interlocking features interconnect the bottom edges of at least two of the side panels, with bottom side edges of the bottom panel. Interlocking features on side edges of each of the side panels interlock with the interlocking features of adjacent side panels. The top panel is mounted on top panel edges of the side panels. The top panel has apertures that enable the pens to be inserted through one of the apertures and partially into an internal chamber formed by the bottom panel, the side panels, and the top panel, once they are fully assembled.

In one embodiment, at least some of the panels, in particular the side panels, are custom manufactured and/or selected so that when they are highly customized to the particular user. In one embodiment, this is accomplished by custom printing at least some of the panels via 3D printing, and then assembling the various panels via interlocking features. The interlocking features may be unique shapes, or they may be common shapes such as circles, triangles, squares, hexagons, etc., which are arranged in unique spacing or combinations, so that each panel can only be connected in the correct orientation and configuration.

A primary objective of the present invention is to provide a modular desk organizer having advantages not taught by the prior art.

Another objective is to provide a modular desk organizer that may be assembled from unique parts that are custom selected to meet the needs of a particular user.

A further objective is to provide a modular desk organizer that is formed from custom 3-D printed panels that are assembled by the user for final use by the user.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a front perspective view of a modular desk organizer according to one embodiment of the present invention.

FIG. 2 is an exploded rear perspective view of the modular desk organizer of FIG. 1, illustrating a bottom panel, a top panel, and a plurality of side panels that support the top panel over the bottom panel.

FIG. 3 is perspective view illustrating the modular desk organizer once all of the side panels have been installed, with the top panel positioned to be mounted upon the side panels.

FIG. 4 is decorative plate mounted on a mounting slot of one of the side panels.

FIG. 5 is a bottom plan view of the bottom panel, illustrating a hidden storage compartment formed in an underside of the bottom panel.

### DETAILED DESCRIPTION OF THE INVENTION

The above-described drawing figures illustrate the invention, a modular desk organizer 10 for organizing office supplies such as pens 12, paper clips, and the like. The modular desk organizer 10 may be constructed of 3D printed components so that it may be highly customized to a particular user.

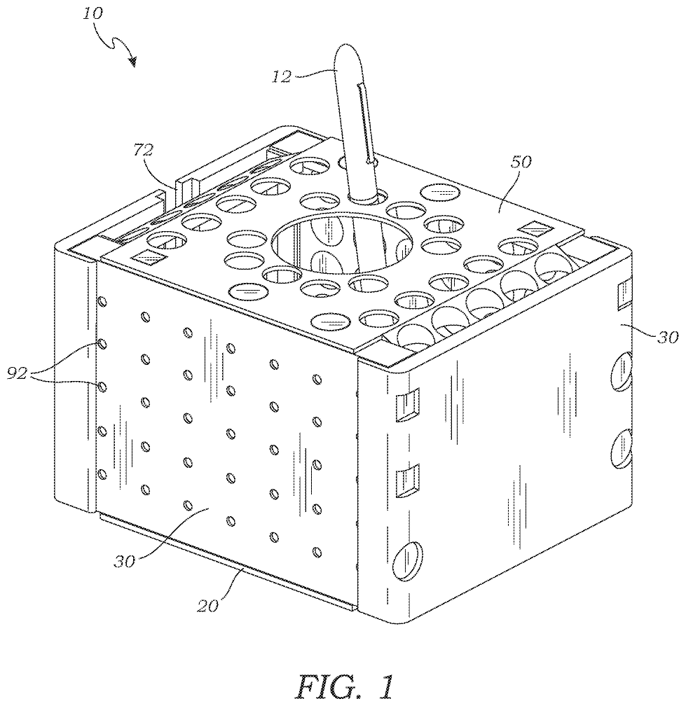

FIG. 1 is a front perspective view of a modular desk organizer 10 according to one embodiment of the present invention. As shown in FIG. 1, the modular desk organizer 10 includes a bottom panel 20, a plurality of side panels 30, and a top panel 50. The side panels 30 support the top panel 50 over the bottom panel 20. In this embodiment there are four side panels 30 disposed in a cuboid shape; however, other numbers of side panels and alternative shapes may be used in different embodiments of the invention.

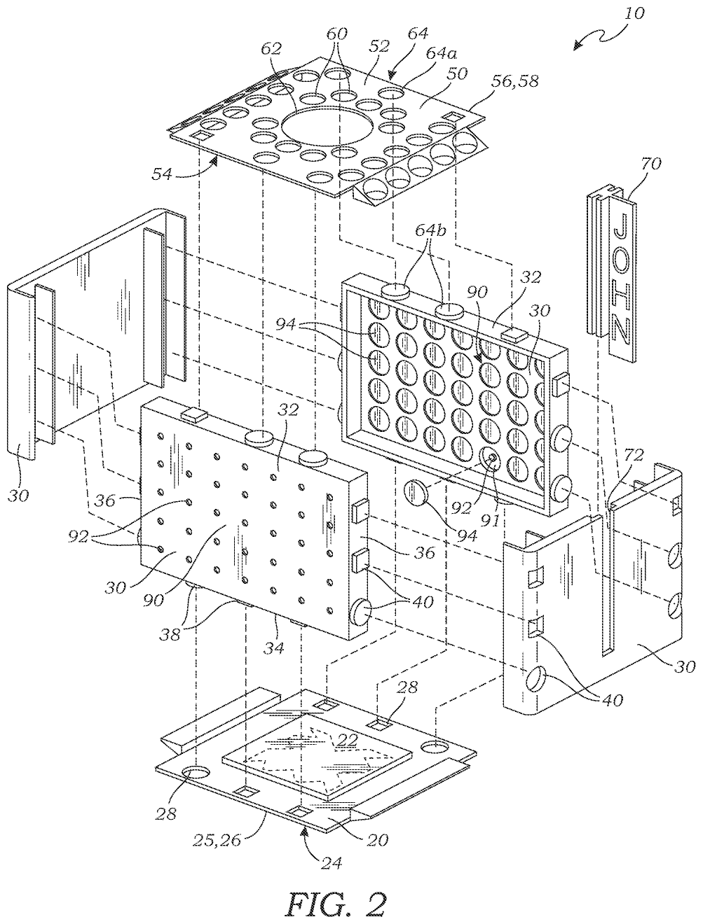

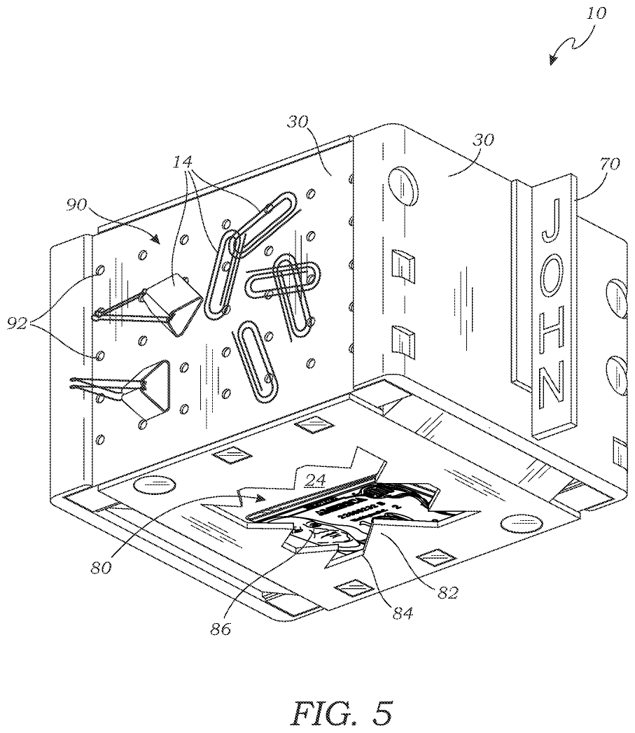

FIG. 2 is an exploded rear perspective view of the modular desk organizer 10 of FIG. 1. As shown in FIG. 2, in this embodiment the bottom panel 20 includes a top surface 22 and an opposed bottom surface 24 (best shown in FIG. 5) that together extend outwardly to a perimeter 25 having bottom side edges 26. Interlocking features 28 are disposed on each of at least two of the bottom side edges 26 of the bottom panel 20. While the interlocking features 28 are disposed on two side edges 26 in this embodiment, they may be disposed on all four edges 26 in other embodiments.

In this embodiment, each of the side panels 30 has a top panel edge 32, a bottom panel edge 34, and opposed side panel edges 36. At least two of the side panels 30 having interlocking features 38 disposed on the bottom panel edge 34, which are each structured to interlock with the interlocking features 28 of one of the side edges 26 of the bottom panel 20.

Furthermore, each of the side panel edges 36 of each of the side panels 30 have interlocking features 40 that interlock with adjacent side panels 30. The interlocking features 28, 38, and 40 may be in the form of posts and receivers having unique shapes which mate and interlock. The interlocking features 28, 38, and 40 may include unique combinations of shapes that are evenly spaced from one another, such as, e.g., circle, triangle, square, hexagon, octagon, and diamond. The shapes may be common shapes such as described, arranged in unique spacing or combinations, so that each panel can only be connected in a particular orientation and configuration; or alternatively, unique shapes may be used, which only interlock with the correct mating shapes. In other embodiments, however, other shapes and interlocking structures (e.g., tongue and groove, snaps, other non-mechanical fasteners, and also including non-mechanical fasteners) may be used, and the panels may be capable of being interlocked in any configuration.

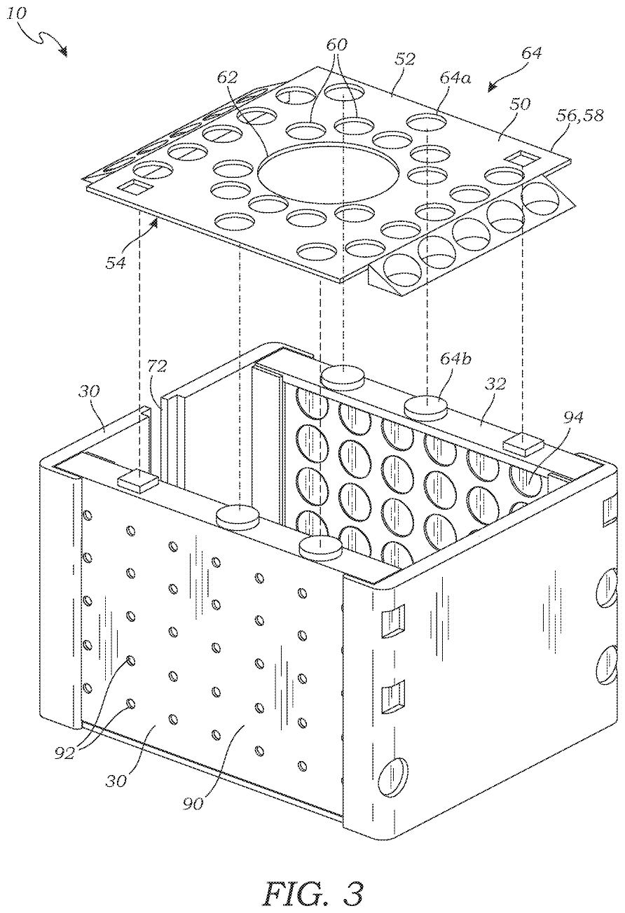

FIG. 3 is perspective view illustrating the modular desk organizer 10 once the side panels 30 have been installed, with the top panel 50 positioned to be mounted upon the side panels 30. As shown in FIG. 3, the top panel 50 of this embodiment includes a top surface 52 and an opposed bottom surface 54 that together extend outwardly to a perimeter 56 having top side edges 58.

As shown in FIG. 3, the top panel 50 includes at least one aperture 60 through the top panel 50 that is sized and shaped (in this case about 0.5 inches) to receive the pens 12 therethrough. One or more of these apertures may be in the form of an oversized aperture 62 that is larger, in this case at least 1.0 inch. The oversized aperture 62 is suitable for holding scissors, rulers, and other larger desk implements. For purposes of this application, the term “pen” is defined to include any elongate writing implement typically used in an office, including any forms of pens, pencils, markers, highlighters, etc.

In the embodiment of FIG. 3, the top panel 50 also includes a means for mounting 64 the top panel 50 on the top panel edges 32 of the side panels 30. In this embodiment, the means for mounting 64 includes receivers 64A on the top panel 50, and posts 64B on the side panels 30; however, in alternative embodiments, the means for mounting 64 may include any of the alternative interlocking structures discussed above, including both mechanical interconnections (e.g., tongue and groove, etc.) and non-mechanical (e.g., magnetic, etc.) interlocking of fastening devices known in the art.

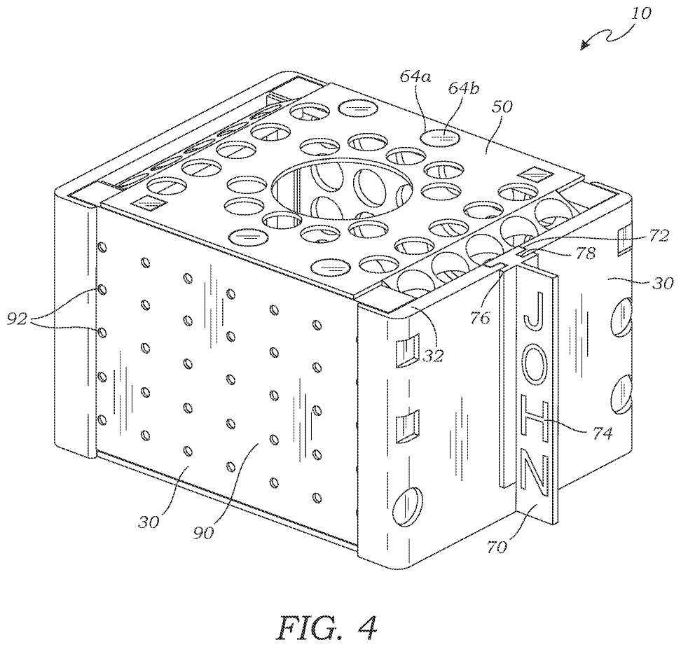

FIG. 4 is decorative plate 70 mounted on a mounting slot 72 of one of the side panels 30. In this embodiment, the decorative plate 70 includes a personal name 74 printed, etched, or otherwise formed on the plate 70. In this embodiment, the mounting slot 72 is in the form of a vertical slot that extends from the top panel edge 32 partially into the side panel 30. The decorative plate 70 may include a vertical ridge 76 having vertical grooves 78 which slidably engage the slot 72 so that the decorative plate 70 is removably mounted on the side panel 30.

FIG. 5 is a bottom plan view of the modular desk organizer 10 illustrating an underside of the bottom panel 20, illustrating a hidden storage compartment 80 formed therein. In this embodiment, the storage compartment 80 includes a compartment sheet 82 that forms an aperture 84 that enables an item 86 (e.g., money, confidential notes, a sheet of passwords, etc.) to be inserted through the aperture 84 and stored between the compartment sheet 82 and the bottom surface 24 of the bottom plate 20. In the preferred embodiment, when the bottom plate 20 is placed upon a surface (such as a desk), the compartment 80 is concealed from view.

As shown in FIG. 2, the modular desk organizer 10 may include at least one side panel 30 that provides a paperclip storage wall 90, that includes a plurality of bores 91 therein, each containing a magnet 94. In this embodiment, each of the bores 91 includes a hole 92 through it, so that the magnet 94 may be pushed out of the bore 91 if needed. As shown in FIG. 5, this paperclip storage wall 90 enables paperclips 14 (e.g., standard paper clips, binder clips, and similar metal office supplies and other items) to be magnetically mounted on the paperclip storage wall 90 for easy access by a user.

In use, the modular desk organizer 10 shown in FIGS. 1-5 is custom manufactured (such as 3D printing) and/or selected from a large stock of options, so that the different panels can be assembled to form an assembled product that is customized to the needs of a particular consumer. This can include, for example, the user's name (e.g., on the decorative plate 70, and/or elsewhere), any number of decorative features which may be selected by the user for printing/etching/otherwise forming on any of the panels described herein, and any other features that may be desired by the user. A wide range of side panels 30 may be selected from to provide the storage capabilities desired by the user. Any customized features that may be devised by one skilled in the art may be included in the present invention, and should be considered within the scope of the present invention.

Once the desired panels are selected and printed or otherwise manufactured, they may be flat packed and shipped, with notable savings in shipping and storage expenses related to the product. Once received by the user, the panels may be readily assembled, as discussed above, to provide the final product for use by the user.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A modular desk organizer for organizing office supplies such as pens, the modular desk organizer comprising:
a bottom panel;
a top panel;
side panels; and
interlocking features that interconnect the bottom edges of at least two of the side panels, with bottom side edges of the bottom panel;
interlocking features on side edges of each of the side panels, the interlocking features interlocking with the interlocking features of adjacent side panels;
the top panel being mounted on top panel edges of the side panels; and
the top panel having apertures that enable the pens to be inserted through one of the apertures and partially into an internal chamber formed by the bottom panel, the side panels, and the top panel, once they are fully assembled.

2. The modular desk organizer of claim 1, wherein one of the side panels includes a plurality of bores, each of the bores containing a magnet.

3. The modular desk organizer of claim 1, wherein one of the side panels includes a vertical slot that extends from the top panel edge partially into the side panel; and further comprising a decorative plate that includes a vertical ridge having vertical grooves which slidably engage the vertical slot so that the decorative plate is removably mounted on the side panel.

4. The modular desk organizer of claim 3, wherein the decorative plate includes a personal name printed upon or otherwise formed by the decorative plate.

5. The modular desk organizer of claim 1, wherein the bottom plate includes a compartment formed in the bottom surface of the bottom plate, so that when the bottom plate is placed upon a surface the compartment is concealed from view.

6. The modular desk organizer of claim 1, wherein the interlocking features include unique combinations of shapes that are evenly spaced from one another.

7. The modular desk organizer of claim 6, wherein the unique combinations of shapes are selected from the following: circle, triangle, square, hexagon, octagon, and diamond.

8. A modular desk organizer for holding office supplies, including pens, the modular desk organizer comprising:
a bottom panel that includes a top surface and an opposed bottom surface that extend outwardly to a perimeter having bottom side edges;
interlocking features on each of at least two of the bottom side edges of the bottom panel;
side panels, each having a top panel edge, a bottom panel edge, and opposed side panel edges;
at least two of the side panels having interlocking features disposed on the bottom panel edge, which are each structured to interlock with the interlocking features of one of the side edges of the bottom panel;
each of the side panel edges of each of the side panels having interlocking features that interlock with adjacent side panels;
a top panel that includes a top surface and an opposed bottom surface that extend outwardly to a perimeter having top side edges;
a means for mounting the top panel on the top panel edges of the side panels; and
at least one aperture through the top panel that is sized and shaped to receive the pens therethrough.
